(19) United States
(12) Patent Application Publication
(10) Pub. No.: US 2003/0046443 A1
(43) Pub. Date: Mar. 6, 2003

(54) Updating mobile agents

(76) Inventors: Roch Glitho, Montreal (CA); Bertrand Lenou Emako, Montreal (CA); Samuel Pierre, Montreal (CA)

Correspondence Address: SANDRA BEAUCHESNE, Ericsson Canada Inc., Patent Department (LMC/UP), 8400 Decarie Blvd., Town Mount Royal, QC, H4P 2N2, CA

(21) Appl. No.: 09/950,236

(22) Filed: Sep. 6, 2001

(51) Int. Cl. G06F 9/44

(52) U.S. Cl. 709/317

(57) ABSTRACT

The invention relates to various embodiments of a method for updating a mobile agent (MA) providing services. The MA resides in a site in a data communications network. In a preferred embodiment a new MA, comprising the desired services, is created. The new MA moves to the site of the old MA where its data is customised. The method then waits until none of the old services in the old MA is running before it deactivates the old MA and activates the new MA. In addition, two further embodiments are provided. Furthermore, an interface manager (IM) for use with interpreted object-oriented programs is provided. The IM acts as a proxy for inter-object calls and has a redirection table in order to redirect object calls to objects that replaced old objects. Also, a method for updating an MA with an IM is provided.

### BACKGROUND OF THE INVENTION

1. Technical Field of the Invention

The present invention relates to data communications networks, and particularly to update of mobile agents in such networks.

2. Description of Related Art

Mobile agents are becoming increasingly common in data communications networks, where they for example may be used for network management or to search for information in the network.

A mobile agent is an intelligent entity that may extend its capabilities by downloading additional program code from a network, and move around between the different nodes in the network. A person skilled in the art knows how this is achieved, but the knowledge is not necessary for the comprehension of the present invention.

In Internet telephony, the network has less intelligence than in a traditional network, which is why the intelligence follows the subscriber, either in the terminal itself, in a mobile agent or a combination thereof. Using mobile agents is thus a way of providing to the subscriber's value added services, such as call forwarding and call barring.

The subscriber decides what value added services are of interest. These services are then put in a mobile agent (MA), such as a mobile service agent (MSA), that then follows the subscriber through the network, for example by being lodged in the subscriber's terminal. The subscriber may then personalise the services in the MSA, for instance by associating a certain number with a certain speed dial button.

A problem occurs when the subscriber wants to update the services in the MSA, for example by adding a new service. The problem is how the MSA should be updated with as little disturbance as possible to the services. It is not sufficient to just create a new MSA comprising all the subscribed to services, and substitute the new MSA for the old MSA, as the personalised (or customised) data would be lost.

It can therefore be understood that there is a need for a solution that allows a MSA in particular, and a MA in general, to be updated in a better way than previously known. This invention provides such a solution.

### SUMMARY OF THE INVENTION

The present invention is directed to a method for updating a first mobile agent (MA) providing at least one service, wherein the first MA resides in a site in a data communications network. The method comprises the steps of creating a second MA, moving the second MA to the site of the first MA, customising the data of the second MA, verifying if the first MA is running any services. If any services are running, the method waits for the services to stop running. When no services are running, the first MA is deactivated and the second MA is activated.

The present invention is also directed to a method for updating a first mobile agent (MA) providing at least one service, wherein the first MA resides in a site in a data communications network. The method comprises the steps of creating a second MA, customising the data of the second MA, noting which services that are running, stopping the running services, deactivating the first MA, sending notification to the second MA, moving the second MA to the site of the first MA, activating the second MA, and restarting the services that were stopped.

The present invention is further directed to a method for updating a first mobile agent (MA) providing at least one service, wherein the first MA resides in a site in a data communications network. The method comprises the steps of creating a second MA, customising the data of the second MA, and verifying if the first MA is running any services. If the first MA is running any services the method waits for the services to stop running. When no services are running, the first MA is deactivated, a notification is sent to the second MA that moves to the site of the first MA and is activated.

The present invention is further directed to a method for updating a mobile agent (MA) being at least partially programmed as classes of an interpreted object-oriented language. The MA provides at least one service and no part of the MA that is to be updated is active. The method comprises the steps of creating new classes, moving the classes to the MA, customising the data for the new classes, and putting each new class in its proper place.

The present invention is further directed to a method for updating a mobile agent (MA) being at least partially programmed as classes of an interpreted object-oriented language. The MA provides at least one service and no part of the MA that is to be updated is active. The method comprises the steps of creating new classes, customising the data for the new classes, moving the classes to the MA, and putting each new class in its proper place.

The present invention is further directed to an interface manager (IM) for handling object calls in a object-oriented language comprising a redirection table and a call handler. The redirection table is for providing a translation of a first object call. The call handler is for receiving a first object call from a first object, requesting a translation of the first object call from the redirection table, calling a second object using the translation of the first object call, receiving a result from the second object, and forwarding the result to the first object.

The present invention is further directed to a method for updating a mobile agent (MA) being at least partially programmed as classes of an interpreted object-oriented language. The method comprises the steps of creating an update message, sending the update message to the MA, storing information from the update message in the MA, and updating classes and objects in the MA using the stored information.

### BRIEF DESCRIPTION OF THE DRAWINGS

A more complete understanding of the present invention may be had by reference to the following Detailed Description when taken in conjunction with the accompanying drawings wherein:

FIG. 1 depicts schematically parts of a mobile agent;

FIG. 2 depicts a simplified block chart of a mobile agent environment;

FIG. 3 depicts a flowchart of a first preferred embodiment of the method according to the invention;

FIG. 4 depicts a flowchart of a second preferred embodiment of the method according to the invention;

FIG. 5 depicts a flowchart of a third preferred embodiment of the method according to the invention;

FIG. 6 schematically depicts the programming code in a mobile agent;

FIG. 7 depicts a flowchart of a fourth preferred embodiment of the method according to the invention;

FIG. 8 depicts a flowchart of a fifth preferred embodiment of the method according to the invention;

FIG. 9 depicts schematically an embodiment of an interface manager (IM) according to the invention; and

FIG. 10 depicts a flowchart of a sixth preferred embodiment of the method according to the invention

### DETAILED DESCRIPTION OF EMBODIMENTS

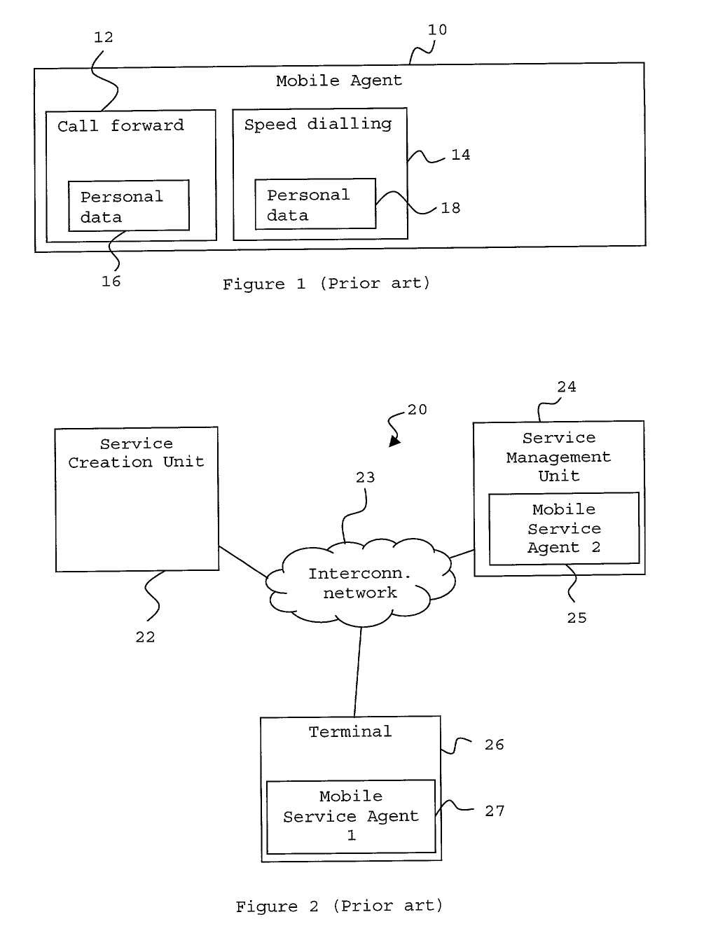

Reference is now made to the Drawings, where FIG. 1 schematically depicts an exemplary mobile agent 10. As an example, the mobile agent 10 is a mobile service agent (MSA) described hereinbefore. The MSA 10 comprises two services; call forwarding 12 and speed dialling 14. The services are, in effect, the executable code for the two services. Both services 12 and 14 comprise personalised data 16 and 18, respectively. This personalised data 16 and 18 may for instance be the particular phone number that the subscriber wants incoming calls forwarded to and phone numbers associated with speed dial buttons.

FIG. 2 depicts a simplified block chart of an exemplary mobile agent environment comprising a data communications network 20. This network 20 comprises a service creation unit (SCU) 22, a service management unit (SMU) 24, and a terminal, the three connected by an interconnecting network 23. The SCU 22 may store services (not shown) and create new services. The services in the SCU 22 may then be used by the SMU 24 for creation of mobile agents, in this example mobile service agents (MSAs). A first MSA 27 resides on the terminal 26, while a second MSA 25 has been created in the SMU 24, as the first MSA 27 is to be updated. As mentioned hereinbefore, a MSA may for example be updated when the subscriber desires the latest version of a service that is already in the first MSA.

As already mentioned, the previously known way of updating a MSA is to create a new MSA (in the figure the second MSA 25) and transferring it to where it is to reside (the terminal 26) and simply substituting the old MSA (the first MSA 27) with the new MSA (the second MSA 25). It may be good to point out once more that doing this will almost certainly erase the personalised data (see FIG. 1) residing in the old MSA. In addition, service interruptions may occur.

To improve the described way of updating a MSA, both when changing existing services and adding new ones, the present invention proposes the concept of agent swapping, for which there are a number of different embodiments, among these are smooth swapping and abrupt swapping, as will be described hereinafter.

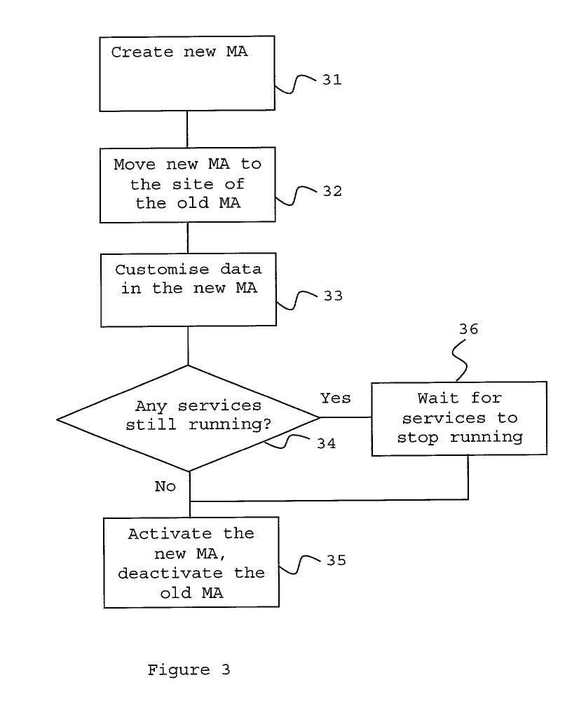

FIG. 3 depicts a flowchart of a first preferred embodiment of the method according to the invention, smooth swapping. A new mobile agent (MA) is created in step 31 by downloading the relevant executable files corresponding to the desired services. The new MA then moves (or is moved) to where the old MA resides, step 32. The data in the new MA is then customised, step 33, either by transferring the customised data from the old MA to the new MA or manually by the subscriber.

In order to make a smooth swap from the old MA to the new MA, no services can run at the time of the swap, as this will interrupt those services. For this reason, in step 34 it is verified whether any services in the old MA are running. If no services are running the method continues with step 35 in which the new MA is activated and the old MA is deactivated. If at least one service is running, then the method moves to step 36, where the method waits for all the services to stop running, i.e. until all the services are non-running, after which the method continues with hereinbefore-mentioned step 35 where the new MA is activated and the old MA is deactivated. The method is then finished and the new MA with customised data has taken the place of the old MA.

Smooth swapping does however require that the old and the new MA co-exist on the same site for at least a short while. This may not always be possible owing to for example limited memory space at the site where the old MA resides. In addition, if a service is permanently active, then smooth swapping is not possible as the method waits for all the services to stop running before the new MA is activated and the old MA is deactivated. For these reasons, a second preferred embodiment of the method according to the invention is needed: abrupt swapping.

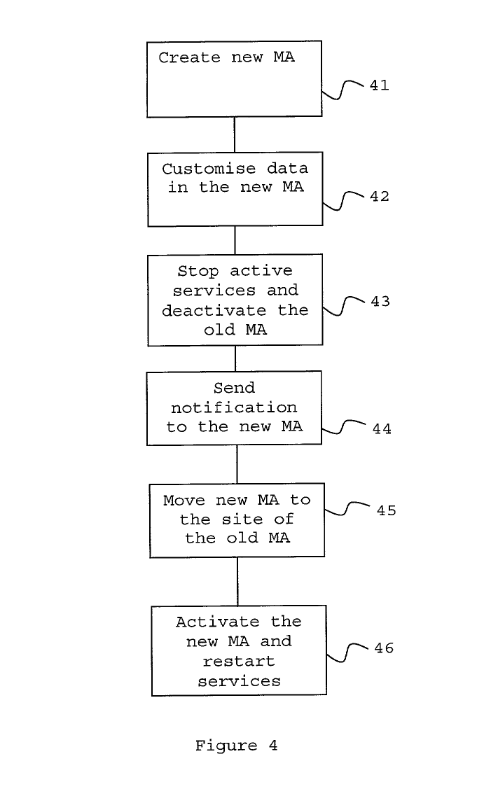

FIG. 4 depicts a flowchart of this second preferred embodiment of the method according to the invention: abrupt swapping. This embodiment of the method starts as the formerly described embodiment with the step of creating the new MA, step 41. Then the data of the new MA is customised, step 42. This is for example done by sending relevant customised data from the old MA to the new MA. In step 43, any active services are stopped and the old MA is deactivated. In addition, a note is made of which services were stopped, which for example can be done by storing the note in a memory at the site of the old MA or by sending the information to the new MA. The new MA is then notified that the old MA is deactivated, step 44. The notification may comprise information on what services were interrupted in step 43. Upon reception of the notification, the new MA moves to the site of the old MA, step 45, and in step 46 the new MA is activated and the services that were stopped are restarted. The method is the finished and the new MA is activated with customised data.

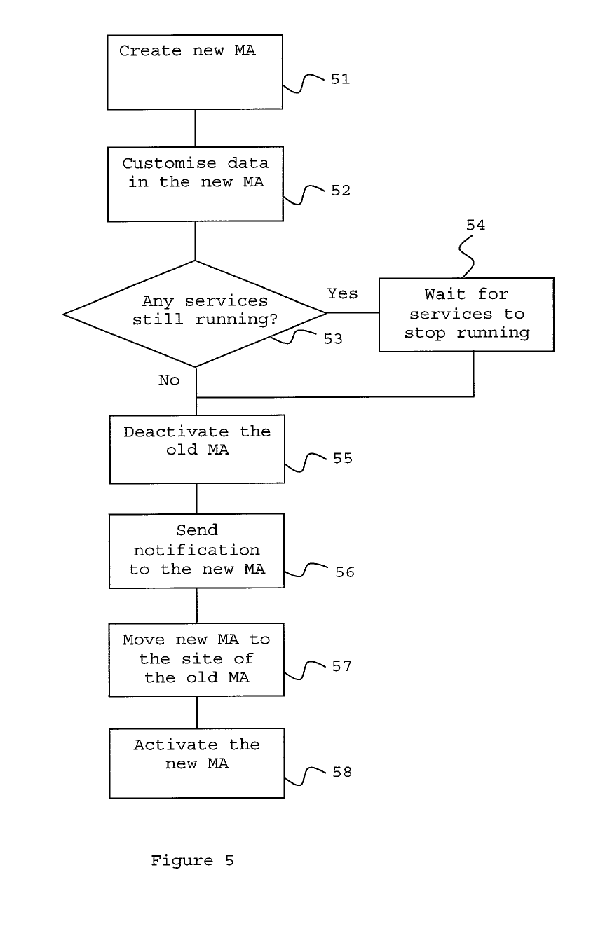

FIG. 5 depicts a flowchart of a third preferred embodiment of the method according to the invention, which can be said to be a hybrid between smooth and abrupt swapping.

The first two steps of this embodiment of the method are the same as the first two steps of the method described in FIG. 4, create the new MA (step 51) and customise the data in the new MA (step 52).

The method then verifies if any services are running, step 53, and if so proceeds to wait for all the services to stop running, step 54. This is also described in steps 34 and 36 of the method described in FIG. 3.

If no services are running, i.e. when all the services are non-running, the old MA is deactivated in step 55. A notification that the old MA is deactivated is then sent to the new MA, step 56, and the new MA moves to the site of the old MA, step 57. These two steps are also described in steps 44 and 45 in FIG. 4.

The last step, step 58, of the method is the activation of the new MA. The method is then finished and the new MA is activated with customised data.

The descriptions of the methods so far have been generic in the sense that they work for many kinds of programming languages. For interpreted object-oriented programming languages such as for example Java and C++ however, the methods may be modified to reduce the amount of transferred data as will be explained hereinafter.

To understand how the amount of transferred data can be reduced, it is necessary to have some knowledge of these languages. A program written in such a language normally comprises a usually small “main” program used among other things to start the program, and a number of classes from which objects can be created. An object comprises references to other objects and invokes methods of those objects. The classes can be dynamically loaded in the memory, meaning that they are resolved only at invocation time, which is why they can be transferred over a network.

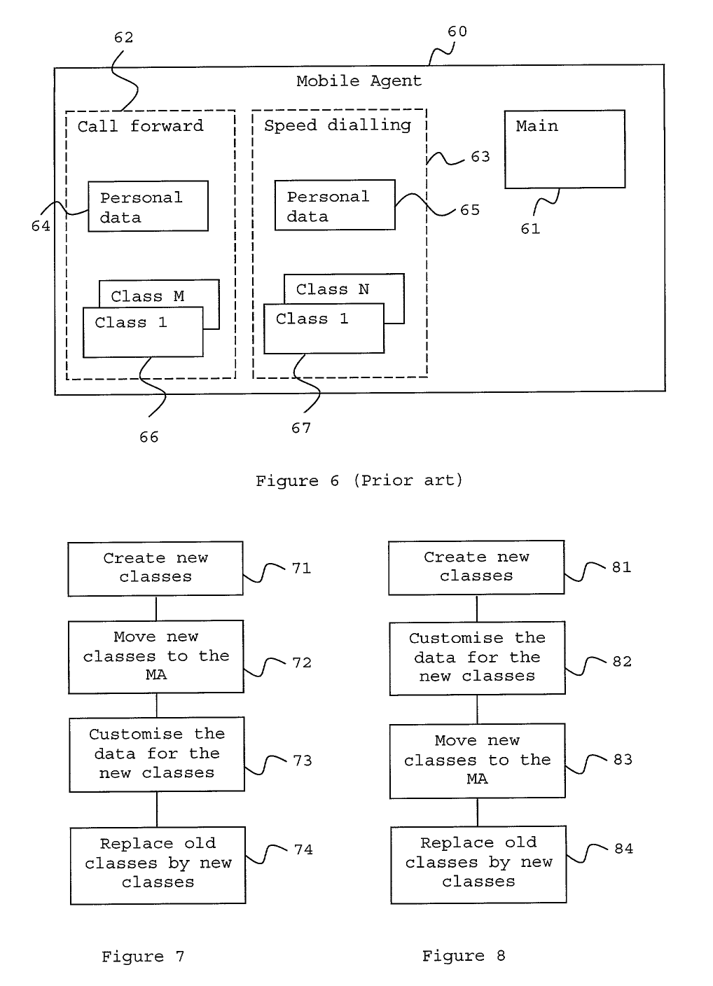

FIG. 6 schematically depicts programming code written in an interpreted object-oriented language in a mobile agent. The mobile agent 60 comprises a main module 61 that usually is small and generic, and code and data for two services: call forwarding 62 and speed dialling 63. The services 62 and 63 both comprise personalised data 64 and 65 respectively, which also can comprise data relevant to an active session even though this data is not personalised by the user, but rather by the program itself. Each service also comprises a number of classes 66 and 67 respectively.

Assume that the subscriber wants to install a new version of call forwarding. For now, it will also be assumed that call forwarding is not active, i.e. no part of the program is active. According to the methods previously described, a new MSA is constructed, personalised and activated. This means that the main module and the classes for both call forwarding and speed dialling will be transferred, even though it is only one or more classes for call forwarding that need be changed. This is achieved by the following embodiments of the method according to the invention.

FIG. 7 depicts a flowchart of a fourth preferred embodiment of the method according to the invention. The new class or classes are created in step 71 by downloading the relevant executable files. The new classes are then moved to where the MA resides, step 72. The data for the new classes is then customised, step 73.

Customising the data may for example be done by defining tag values and fields that the agent is aware of. The agent keeps a file listing each parameter and its value. To customise the agent, it simply reads the file and associates the value with each parameter.

As the service for which the classes are used is not active, there is no need to wait to make the swap from old classes to new classes, which is done in step 74 after which the method is finished and the new class or classes with customised data have taken the place of the old class or classes. Naturally, new classes that have no corresponding old class do not replace any class. Whether the class replaces an old class or not, this is where the new class is put in its proper place.

FIG. 8 depicts a flowchart of a fifth preferred embodiment of the method according to the invention. The new class or classes are created in step 81 by downloading the relevant executable files. The data for the new classes is then customised, step 82, for example by requesting the values of the parameters from the MA.

The new classes are then moved to where the MA resides, step 83. As the service or services for which the classes are used are not active, there is no need to wait to make the swap from old classes to new classes, which is done in step 84 after which the method is finished and the new class or classes with customised data have taken the place of the old class or classes. As in FIG. 7, the classes are put in their proper places, whether they replace an old class or not.

If an active service is to be updated, then the fourth and fifth embodiments of the method may still be used, although they may cause service interruptions. This is because references to objects that are changed could become obsolete, thereby causing the program to crash. The solution to this problem will now be described.

It is still assumed that the subscriber wants to install a new version of call forwarding. However, contrary to the previous two embodiments, it is also assumed that call forwarding is active.

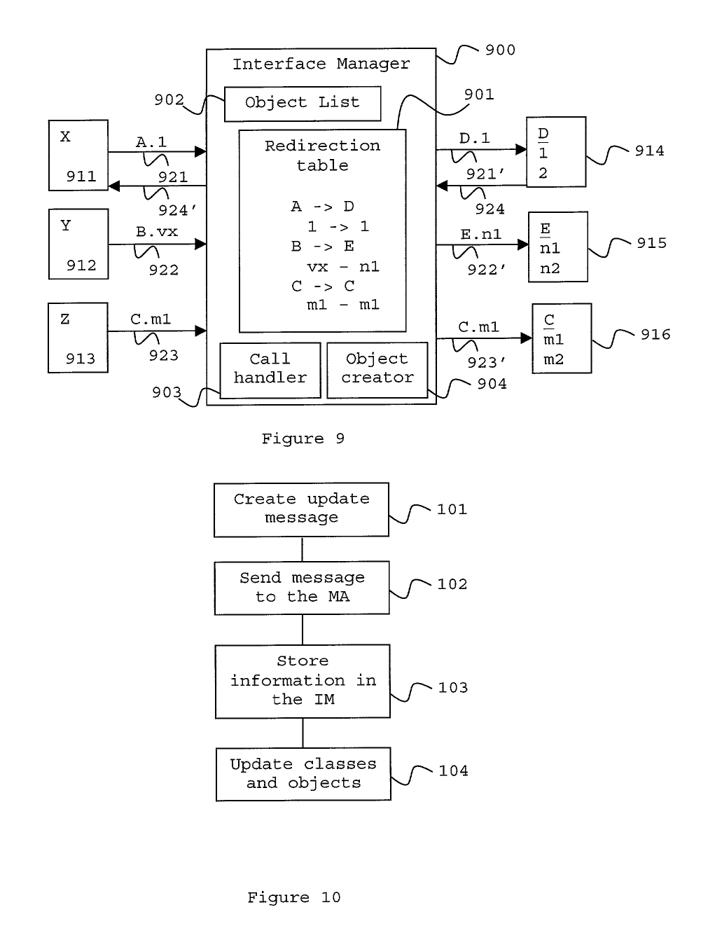

Attention is now brought to FIG. 9 that schematically depicts an embodiment of an interface manager (IM) according to the invention. The program code for the objects 911-916 is written so that an object 911-913 always calls other objects 914-916 through the IM 900, although any object 911-916 may call itself without going through the IM 900. The IM 900 acts as a proxy that directs and possibly modifies calls to an object 914-916 made by other objects 911-913. This is possible since an object has proxies of references to other objects rather than direct references to the objects. In the IM 900, it is the call handler 903 that handles these object calls.

Upon reception of an object call 921-923, the call handler 903 in the IM 900 directs, and possibly also modifies, the call 921-923 according to a redirection table 901 (with some examples shown in the figure), which results in a second object call 921′-923′, as will be illustrated by a few examples.

Object X 911 calls method 1 of object A (illustrated by A.1) in object call 921, although the call is sent to the IM 900. Upon reception of the object call 921, the call handler 903 in the IM 900 consults the redirection table 901 that states that calls for object A (not shown) should now be directed to object D 914 and that method 1 for object A 911 corresponds to method 1 in object D 914 (the methods of objects 914-916 are indicated below the names of the objects 914-916). The IM 900 then issues an object call 921′ calling method 1 of object D 914. When the call handler 903 in the IM 900 receives a response on an object call it passes the response on to the calling object 911-913; e.g. the response 924 to object call 921′ is passed on to object X 911 as response 924′.

In a similar way, the object call “B.vx” 922 (method vx of object B) from object Y 912 is redirected as object call “E.n1” 922′ (method n1 of object E), and the object call “C.m1” 923 (method m1 of object C) from object Z 913 is redirected as object call “C.m1” 923′ (the same), as object C 916 is unchanged.

Furthermore, when an object is created, it is the object creator 904 in the IM 900 that creates the object. For every object creation, the IM 900 holds the real implementation of the class and returns a proxy to the calling object. The IM 900 also keeps an object list 902 of all the created objects.

FIG. 10 shows a flowchart of a sixth preferred embodiment of the method according to the invention. It is still assumed that the subscriber wants to update the call forwarding service, and that the service is active.

At first, an update message is created in step 101. The update message comprises the code for the new classes, information for the redirection table (901 in FIG. 9) if applicable (i.e. how calls should be redirected), and information as to what class or classes, if any, each new class replaces. This update message is then in step 102 sent to the MA (not shown) that, upon reception of the message, in step 103 stores the information in the message in its appropriate place; e.g. redirection information in the redirection table 901, and new classes along with the rest of the code, possibly overwriting the old classes, as indicated in the message. Finally, in step 104, the IM 900 uses the object list 902 to create new objects to replace the corresponding old objects. As the new objects implement the new features of call forwarding, the call forwarding service (and thus the MA) is dynamically updated without service interruption.

Thus it can be seen that the present invention provides improved update of mobile agents, both when changing existing services and adding new ones.

Although several preferred embodiments of the methods, systems and nodes of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for updating a first mobile agent (MA) providing at least one service, wherein the first MA resides in a site in a data communications network, the method comprising the steps of:
creating a second MA;
moving the second MA to the site of the first MA;
customising the data of the second MA;
verifying if the first MA is running any services; and
if so, waiting for the services to stop running;
when no services are running, deactivating the first MA and activating the second MA.

2. A method for updating a first mobile agent (MA) providing at least one service, wherein the first MA resides in a site in a data communications network, the method comprising the steps of:
creating a second MA;
customising the data of the second MA;
noting which services are running;
stopping the running services;
deactivating the first MA;
sending a notification to the second MA;
moving the second MA to the site of the first MA;
activating the second MA; and
restarting the services that were stopped.

3. A method for updating a first mobile agent (MA) providing at least one service, wherein the first MA resides in a site in a data communications network, the method comprising the steps of:
creating a second MA;
customising the data of the second MA;
verifying if the first MA is running any services; and
if so, waiting for the services to stop running;
when no services are running, deactivating the first MA;
sending a notification to the second MA;
moving the second MA to the site of the first MA; and
activating the second MA.

4. A method for updating a mobile agent (MA), the MA being at least partially programmed as classes of an interpreted object-oriented language, the MA providing at least one service and where no part that is to be updated is active, the method comprising the steps of:
creating new classes;
moving the classes to the MA;
customising the data for the new classes; and
putting each new class in its proper place.

5. The method according to claim 4, wherein the step of putting each new class in its proper place comprises the step of replacing an old class with the new class.

6. A method for updating a mobile agent (MA), the MA being at least partially programmed as classes of an interpreted object-oriented language, the MA providing at least one service and where no part that is to be updated is active, the method comprising the steps of:
creating new classes;
customising the data for the new classes;
moving the classes to the MA; and
putting each new class in its proper place.

7. The method according to claim 6, wherein the step of putting each new class in its proper place comprises the step of replacing an old class with the new class.

8. An interface manager (IM) for handling object calls in a object-oriented language, the IM comprising:
a redirection table for providing a translation of a first object call; and
a call handler for:
receiving a first object call from a first object;
requesting a translation of the first object call from the redirection table;
calling a second object using the translation of the first object call;
receiving a result from the second object; and
forwarding the result to the first object.

9. The interface manager according to claim 8, further comprising an object creator for creating new objects.

10. The interface manager according to claim 9, further comprising an object list for created objects.

11. A method for updating a mobile agent (MA), the MA being at least partially programmed as classes of an interpreted object-oriented language, the method comprising the steps of:
creating an update message;
sending the update message to the MA;
storing information from the update message in the MA; and
updating classes and objects in the MA using the stored information.

12. The method according to claim 11, wherein the update message comprises code for the new classes, information as to where the code is to be used, and redirection information for object calls.

13. The method according to claim 12, wherein the step of storing information from the update message in the MA comprises the step of storing the redirection information and the code for the new classes.

14. The method according to claim 13, wherein a new class is stored in the place of an old class if this is indicated by the update message.

15. The method according to claim 11, wherein the step of updating classes and objects in the MA comprises using an object list to create new versions of objects of updated classes.
